(19) United States
(12) Patent Application Publication
(10) Pub. No.: US 2026/0296405 A1
(43) Pub. Date: Oct. 1, 2026

(54) Parking Assistance Method and Parking Assistance Device

(71) Applicant: Nissan Motor Co., Ltd., Yokohama-shi, Kanagawa (JP)

(72) Inventors: Yusuke Musha, Kanagawa (JP); Yasuhiro Suzuki, Kanagawa (JP); Muku Takeda, Kanagawa (JP)

(21) Appl. No.: 18/881,801

(22) PCT Filed: Jul. 11, 2022
(86) PCT No.: PCT/JP2022/027273

§ 371 Date: Jan. 7, 2025

(51) Int. Cl. B60W 30/06; B60R 1/22; B60W 50/14; G06V 20/58; H04N 7/18

(52) U.S. Cl. CPC B60W 30/06; B60R 1/22; B60W 50/14; G06V 20/586; B60R 2300/20; B60R 2300/607; B60W 2050/146; H04N 7/183

(57) ABSTRACT

A parking assistance method includes: generating an overhead view image of surroundings of the own vehicle; and displaying the overhead view image and a guide figure representing an area of a predetermined size surrounding a target parking position in a predetermined display region on a display screen. In a case where when an overhead view image is displayed at a first display position, a predetermined area or more in the guide figure can be displayed within the display region, an overhead view image is displayed at the first display position, and in a case where when an overhead view image is displayed at the first display position, the predetermined area or more in the guide figure cannot be displayed within the display region, an overhead view image is displayed at a second display position, the second display position being different from the first display position.

### TECHNICAL FIELD

The present invention relates to a parking assistance method and a parking assistance device.

### BACKGROUND

A parking assistance device described in JP 2008-80959 A described below draws an extension line of a target parking frame and an estimated track line of an own vehicle on an overhead view image generated from an image capturing surroundings of the own vehicle when the target parking frame is located outside the overhead view image.

### SUMMARY

However, when the own vehicle is located apart from a target parking position and a display position of the target parking frame is set outside an area of the overhead view image, a relative position of the target parking frame with respect to the own vehicle cannot be correctly grasped.

An object of the present invention is to provide an image that facilitates grasping of a relative position of a target parking frame with respect to an own vehicle even when the own vehicle is located apart from a target parking position.

According to an aspect of the present invention, there is provided a parking assistance method including: setting a target parking position at which an own vehicle is to be parked; generating an overhead view image of surroundings of the own vehicle from a captured image obtained by capturing surroundings of the own vehicle; and displaying the overhead view image and a guide figure representing an area of a predetermined size surrounding the target parking position in a predetermined display region on a display screen visually recognizable by a passenger of the own vehicle, wherein in a case where when an overhead view image is displayed at a first display position on the display screen, a predetermined area or more in the guide figure can be displayed within the display region, the parking assistance method displays an overhead view image at the first display position on the display screen, and in a case where when an overhead view image is displayed at the first display position on the display screen, the predetermined area or more in the guide figure cannot be displayed within the display region, the parking assistance method displays an overhead view image at a second display position on the display screen, the second display position being different from the first display position.

According to an aspect of the present invention, it is possible to provide an image that facilitates grasping of a relative position of a target parking frame with respect to an own vehicle even when the own vehicle is located apart from a target parking position.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrative of a schematic configuration example of a parking assistance device;

FIG. 2A is an explanatory diagram of an example of processing of registering a target parking position, and FIG. 2B is an explanatory diagram of an example of processing performed when parking assistance is performed;

FIG. 3 is a block diagram of an example of a functional configuration of a controller in FIG. 1;

FIGS. 4A to 4C are explanatory diagrams of an example of a parking assistance method of a first embodiment;

FIGS. 5A to 5D are schematic diagrams of examples of superimposition of a target parking frame;

FIG. 6 is a flowchart of an example of the parking assistance method of the first embodiment;

FIGS. 7A and 7B are explanatory diagrams of an example of a parking assistance method of a second embodiment; and

FIG. 8 is a flowchart of an example of the parking assistance method of the second embodiment.

### DETAILED DESCRIPTION

### First Embodiment

### Configuration

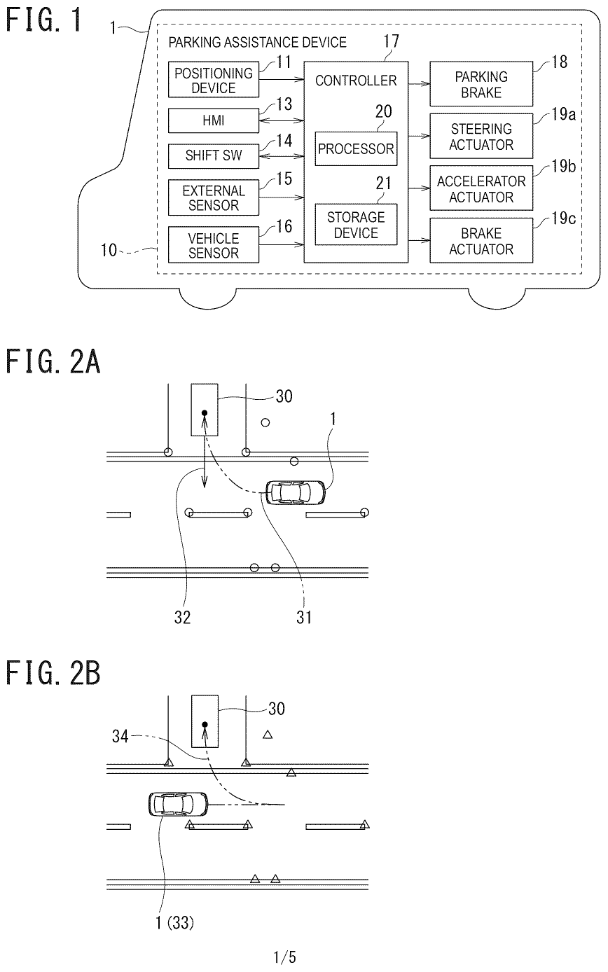

FIG. 1 is now referred to. An own vehicle 1 includes a parking assistance device 10 configured to assist parking of the own vehicle 1 at a target parking position. The parking assistance device 10 assists the own vehicle 1 in traveling along a target travel trajectory from a current position of the own vehicle 1 to the target parking position. For example, the parking assistance device 10 may perform autonomous driving in which the own vehicle 1 is controlled to autonomously travel to the target parking position along the target travel trajectory of the own vehicle 1 (that is, control to cause the own vehicle 1 to control all or some of a steering angle, driving force, and braking force thereof and autonomously perform all or a portion of travel of the the own vehicle 1 along the target travel trajectory). The parking assistance device 10 may assist parking of the own vehicle 1 by displaying the target parking position, the target travel trajectory, and the current position of the own vehicle 1 on a display device that a passenger (for example, a driver) of the own vehicle 1 can visually recognize.

A positioning device 11 measures a self-position that is the current position and a posture (for example, a longitudinal direction of a vehicle body) of the own vehicle 1. The positioning device 11 includes a global navigation satellite system (GNSS) receiver, such as a global positioning system (GPS) receiver. Human-machine interfaces (HMIs) 13 are interface devices configured to transfer information between the parking assistance device 10 and the passenger and include the display device that has a display screen that the passenger can visually recognize, a speaker, a buzzer, and an operation element. A shift switch (shift SW) 14 is a switch for the passenger of the own vehicle 1 or the parking assistance device 10 to switch a shift position of the own vehicle 1.

External sensors 15 detect an object existing in a predetermined distance area from the own vehicle 1. The external sensors 15 detect a surrounding environment of the own vehicle 1, such as a relative position between an object existing in surroundings of the own vehicle 1 and the own vehicle 1, distance between the own vehicle 1 and the object, and a direction in which the object exists. The external sensors 15 may include, for example, a camera to capture an image depicting the surrounding environment of the own vehicle 1. In the following description, the camera included in the external sensors 15 is simply referred to as “camera”. The external sensors 15 may include a ranging device, such as a laser range finder, a radar, and a LiDAR. Vehicle sensors 16 detect various information (vehicle information) about the own vehicle 1. The vehicle sensors 16 may include, for example, a vehicle speed sensor, wheel speed sensors, a triaxial acceleration sensor configured to detect acceleration in three axial directions of the own vehicle 1, a steering angle sensor configured to detect a steering angle, a turning angle sensor configured to detect a turning angle of steered wheels, a gyro sensor, and a yaw rate sensor.

A controller 17 is an electronic control unit that performs parking assistance control. The controller 17 includes a processor 20 and peripheral components, such as a storage device 21. The processor 20 may be, for example, a CPU or an MPU. The storage device 21 may include a semiconductor storage device, a magnetic storage device, an optical storage device, or the like. Functions of the controller 17 may be achieved by, for example, the processor 20 executing computer programs stored in the storage device 21. A steering actuator 19a controls steering direction and the amount of steering of a steering mechanism of the own vehicle 1 in accordance with a control signal from the controller 17. An accelerator actuator 19b controls accelerator opening of a drive device, which is an engine or a drive motor, in accordance with a control signal from the controller 17. A brake actuator 19c causes a braking device to operate in accordance with a control signal from the controller 17.

Next, the parking assistance control performed by the parking assistance device 10 will be described. When the parking assistance performed by the parking assistance device 10 is used, a target parking position at which the own vehicle 1 is to be parked is registered in the parking assistance device 10. Specifically, a target object existing in the surroundings of the target parking position is extracted and stored in the storage device 21 in advance. In the following description, a target object in the surroundings of the target parking position to be stored in the storage device 21 is referred to as “learned target object”. FIG. 2A is an explanatory diagram of an example of processing of registering a target parking position, and circular marks represent learned target objects. When a target parking position 30 is registered in the parking assistance device 10, the passenger performs an operation to instruct registration of the target parking position 30 (hereinafter, sometimes referred to as “registration operation”). The registration operation may, for example, be an operation of a “parking position registration switch” that is prepared in the HMIs 13.

For example, the parking assistance device 10 detects surroundings of the own vehicle 1 by the external sensors 15 and stores a detected object as a learned target object when the own vehicle 1 is positioned in a vicinity of the target parking position 30 (for example, when the passenger parks the own vehicle 1 at the target parking position 30 by manual driving). For example, the parking assistance device 10 may detect a target object from a surrounding image that is obtained by capturing the surroundings of the own vehicle 1 by the camera. In this case, the parking assistance device 10 detects, as a target object, an edge point where luminance changes between adjacent pixels by a predetermined amount or more or a point having a characteristic shape (a feature point), such as an edge or a corner of a target object like a pavement marking, a road boundary, an obstacle, or the like, in the surrounding image. The parking assistance device 10 may detect a target object in the surroundings of the own vehicle 1, using the ranging device.

The parking assistance device 10 stores learned target object data relating to a learned target object in the storage device 21. For example, the learned target object data include data representing a feature amount of a learned target object (hereinafter, referred to as “feature amount data”), data representing a relative positional relationship between the learned target object and the target parking position (hereinafter, referred to as “relative position data”), and coordinate data of the target parking position 30 (hereinafter, referred to as “target parking position coordinate data”).

For example, a relative position of a learned target object with respect to the target parking position 30 may be stored as the relative position data. The parking assistance device 10 can acquire a position of a learned target object detected when the own vehicle 1 is positioned at the target parking position 30 as a relative position of the learned target object with respect to the target parking position 30. For example, the passenger may input a fact that the own vehicle 1 is positioned at the target parking position 30, by operating an HMI 13. Instead of this configuration, the parking assistance device 10 may store coordinates of a learned target object and the target parking position 30 in a coordinate system with a fixed point as a reference point (hereinafter, referred to as “map coordinate system”).

The parking assistance device 10 stores coordinate data of the target parking position 30 in the map coordinate system and angle data indicating a longitudinal direction 32 of a parking space in which the vehicle is to be parked at the target parking position 30, as the target parking position coordinate data. The parking assistance device 10 may store the self-position of the own vehicle 1 in the map coordinate system and the longitudinal direction of the vehicle body when the own vehicle 1 is positioned at the target parking position 30, as the target parking position coordinate data.

FIG. 2B is an explanatory diagram of an example of processing performed when parking assistance is performed. The parking assistance device 10 starts the parking assistance for the own vehicle 1 when the own vehicle 1 is positioned in the vicinity of the registered target parking position 30 and an operation by the passenger to instruct start of the parking assistance control to assist parking of the own vehicle 1 at the target parking position 30 (hereinafter, sometimes referred to as “starting operation”) is performed. The starting operation may be, for example, an operation of a “parking assistance start switch” prepared in the HMIs 13 or may be shift operation for turnabout in which forward movement and backward movement of the own vehicle 1 are switched (for example, a switching operation from a drive range (D range) to a reverse range (R range) or a switching operation from the R range to the D range).

The parking assistance device 10 extracts a target object in the surroundings of the own vehicle 1 from a surrounding image that is obtained by capturing the surroundings of the own vehicle 1 with the camera. In the following description, a target object in the surroundings of the own vehicle 1 that is extracted when the parking assistance is performed is referred to as “surrounding target object”. In FIG. 2B, triangular marks represent surrounding target objects. The parking assistance device 10 matches a learned target object stored in the storage device 21 and a surrounding target object with each other and associates the same feature points with each other. The parking assistance device 10 calculates a relative position of the own vehicle 1 with respect to the target parking position 30, based on a relative positional relationship between a surrounding target object detected when the parking assistance is performed and the own vehicle 1 and a relative positional relationship between a learned target object associated with the surrounding target object and the target parking position 30. For example, the parking assistance device 10 calculates a position of the target parking position 30 in a coordinate system with reference to the current position of the own vehicle 1 (hereinafter, referred to as “vehicle coordinate system”). Note that when coordinates of the learned target object and the target parking position 30 in the map coordinate system are stored in the storage device 21, the parking assistance device 10 may convert the coordinates of the target parking position 30 in the map coordinate system to coordinates in the vehicle coordinate system, based on the position of the surrounding target object detected when the parking assistance is performed and the position of the learned target object in the map coordinate system. The parking assistance device 10 may calculate the self-position of the own vehicle 1 in the map coordinate system, based on the position of the surrounding target object detected when the parking assistance is performed and the position of the learned target object in the map coordinate system, and calculate the relative position of the own vehicle 1 with respect to the target parking position 30 from a difference between the coordinates of the own vehicle 1 and the coordinates of the target parking position 30 in the map coordinate system.

The parking assistance device 10 calculates a target travel trajectory 34 starting from a current position 33 of the own vehicle 1 and reaching the target parking position 30, based on the relative position of the own vehicle 1 with respect to the target parking position 30. The parking assistance device 10 performs the parking assistance control of the own vehicle 1, based on the calculated target travel trajectory 34.

Further, the parking assistance device 10 generates an overhead view image (an around view monitoring image) of the surroundings of the own vehicle 1 from a captured image generated by the camera and displays the overhead view image on the display device in the HMIs 13 by superimposing a target parking frame, the target parking frame indicating a parking space when the vehicle is to be parked at the target parking position 30, in the overhead view image. The target parking frame is an example of a “guide figure representing an area of a predetermined size surrounding the target parking position” described in the claims.

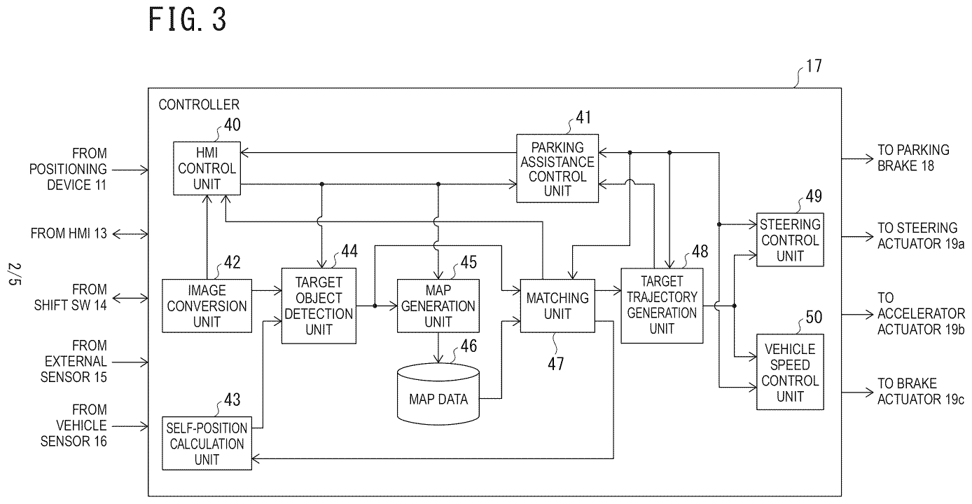

A functional configuration of the controller 17 will be described in more detail below. FIG. 3 is a block diagram of an example of a functional configuration of the controller 17.

An HMI control unit 40 detects a registration operation of a target parking position 30 performed by the passenger and a starting operation of the parking assistance control to assist parking at the registered target parking position 30. When the HMI control unit 40 detects the registration operation, the HMI control unit 40 outputs a map generation command to cause learned target object data to be stored in the storage device 21 to a map generation unit 45. When the HMI control unit 40 detects the starting operation, the HMI control unit 40 outputs a control start command to start the parking assistance control to assist parking of the own vehicle 1 at the target parking position 30, to a parking assistance control unit 41. An image conversion unit 42 converts a captured image captured by the camera to an overhead view image that is an image viewed from a virtual viewpoint directly above the own vehicle 1. The image conversion unit 42 generates a surrounding image that is an image depicting the surrounding region of the own vehicle 1 by converting a captured image to an overhead view image at a predetermined interval (for example, every time the own vehicle 1 travels a predetermined distance (for example, 50 cm) or travels for a predetermined time (for example, for one second)) and accumulating converted overhead view images along a travel route of the own vehicle 1.

A self-position calculation unit 43 calculates a self-position that is a current position and a posture (for example, the longitudinal direction of the vehicle body) of the own vehicle 1 in the map coordinate system by odometry (for example, dead reckoning) based on vehicle information output from the vehicle sensors 16. The self-position calculation unit 43 corrects a calculation result of the self-position and the posture, based on a detection result of the self-position and the posture detected by the positioning device 11. The target object detection unit 44 detects a target object from a surrounding image output from the image conversion unit 42. The target object detection unit 44 may detect a position of a feature point of a target object and an image feature amount of the feature point as a target object. For detection of a position of a feature point and calculation of an image feature amount, various methods, such as SIFT, SURF, ORB, BRIAK, KAZE, and AKAZE, can be made use of. The target object detection unit 44 outputs the detected position and image feature amount of the feature point to the map generation unit 45 and the matching unit 47 as target object data. In addition, the target object detection unit 44 outputs the self-position acquired from the self-position calculation unit 43 in synchronization with the detection of the target object to the map generation unit 45 and the matching unit 47.

When the map generation unit 45 receives a map generation command from the HMI control unit 40 (that is, when the registration operation of the target parking position 30 is performed), the map generation unit 45 generates learned target object data and stores the generated learned target object data in the storage device 21 as map data 46. For example, the map generation unit 45 receives target object data and the self-position of the own vehicle 1 in the map coordinate system that is synchronous with the target object data from the target object detection unit 44.

The map generation unit 45 acquires coordinate data of the target parking position 30 in the map coordinate system and angle data of the longitudinal direction 32 of the parking space in which the vehicle is to be parked at the target parking position 30. For example, the map generation unit 45 may acquire a self-position that the self-position calculation unit 43 calculates as the coordinate data of the target parking position 30 and acquire an angle of the longitudinal direction of the vehicle body as the angle data of the longitudinal direction 32 when the own vehicle 1 is positioned at the target parking position 30.

The map generation unit 45 generates relative position data, based on a position of a feature point included in the target object data, position information of the own vehicle 1 synchronous with the position of the feature point, and position data of the target parking position 30. In addition, the map generation unit 45 acquires feature amount data from the target object data. The map generation unit 45 uses the position data of the target parking position 30 and the angle data of the longitudinal direction 32 of the parking space as target parking position coordinate data. The map generation unit 45 stores learned target object data including the above-described relative position data, feature amount data, and target parking position coordinate data in the storage device 21 as the map data 46.

When the parking assistance control unit 41 receives a control start command from the HMI control unit 40 (that is, when the starting operation of the parking assistance control is performed), the parking assistance control unit 41 outputs a parking position calculation command to the matching unit 47. The matching unit 47 receives target object data output from the target object detection unit 44 as target object data of a surrounding target object and also receives the self-position of the own vehicle 1 in the map coordinate system in synchronization with the reception of the target object data.

The matching unit 47 retrieves the learned target object data stored in the storage device 21 as the map data 46 and determines whether or not the own vehicle 1 is positioned in the vicinity of the registered target parking position 30, based on the target parking position coordinate data. When the own vehicle 1 is positioned in the vicinity of the registered target parking position 30, the matching unit 47 matches a learned target object stored in the map data 46 with a surrounding target object and associates target objects having the same feature point with each other. The matching unit 47 calculates a current relative position of the own vehicle 1 with respect to the target parking position 30, based on a relative positional relationship between a surrounding target object and the own vehicle 1 and a relative positional relationship between a learned target object associated with the surrounding target object and the target parking position 30. For example, surrounding target objects are denoted by (xᵢ, yᵢ), and learned target objects each of which is associated with one of the surrounding target objects (xᵢ, yᵢ) are denoted by (xₘᵢ, yₘᵢ) (i=1 to N). The matching unit 47 calculates an affine transformation matrix M_{affine1}, using the following equation, based on a least-square method.

$${[ \begin{matrix}{a}_{1} \\ {a}_{2} \\ {a}_{3} \\ {a}_{4}\end{matrix} ]}_{\text{?}} = {[ {X}_{X}^{T} {X}_{X} ]}^{- 1} {X}_{X}^{T} {X}_{tfm} \qquad [ Math 1$$

$${X}_{x} = [ \begin{matrix}{x}_{m 1} & {y}_{m 1} & 1 & 0 \\ {y}_{m 1} & - {x}_{m 1} & 0 & 1 \\ ⋮ & ⋮ & ⋮ & ⋮ \\ {x}_{m N} & {y}_{m N} & 1 & 0 \\ {y}_{m N} & - {x}_{m N} & 0 & 1\end{matrix} ] {X}_{tfm} = [ \begin{matrix}{x}_{1} \\ {y}_{1} \\ ⋮ \\ {x}_{N} \\ {y}_{N}\end{matrix} ]$$

$${M}_{affine 1} = [ \begin{matrix}{a}_{1} & {a}_{2} & {a}_{3} \\ - {a}_{2} & {a}_{1} & {a}_{4}\end{matrix} ]$$

The matching unit 47 converts a position (targetxₘ, targetyₘ) of the target parking position 30 in the map coordinate system, which is stored in the map data 46, to a position (targetₓ, target_{y}) in the vehicle coordinate system, using the following equation.

$$\{ \begin{matrix}targetx \\ targety\end{matrix} \} = {M}_{affine 1} \{ \begin{matrix}{targetx}_{m} \\ {targety}_{m} \\ 1\end{matrix} \} \qquad [ Math 2 ]$$

Further, the matching unit 47 converts an angle targetyawₘ indicating the longitudinal direction 32 of the parking space at the target parking position 30 in the map coordinate system to an angle targetyaw indicating a direction in the vehicle coordinate system, based on the following equation.

$$targetyaw = {tan}^{- 1} \frac{{a}_{2}}{{a}_{1}} + {targetyaw}_{m} \qquad [ Math 3 ]$$

When a target trajectory generation unit 48 receives a travel trajectory calculation command from the parking assistance control unit 41, the target trajectory generation unit 48 calculates a target travel trajectory starting from the current position of the own vehicle 1 and reaching the target parking position 30 in the vehicle coordinate system and a target vehicle speed profile. When a steering control unit 49 receives a steering control command from the parking assistance control unit 41, the steering control unit 49 controls the steering actuator 19a in such a way that the own vehicle 1 travels along the target travel trajectory. When a vehicle speed control unit 50 receives a vehicle speed control command from the parking assistance control unit 41, the vehicle speed control unit 50 controls the accelerator actuator 19b and the brake actuator 19c in such a way that vehicle speed of the own vehicle 1 changes in accordance with the target vehicle speed profile. When the own vehicle 1 reaches the target parking position 30 and the parking assistance control is completed, the parking assistance control unit 41 causes a parking brake 18 to operate and switches the shift position to a parking range (P range).

While the parking assistance control is performed, the HMI control unit 40 receives an overhead view image of the surroundings of the own vehicle 1 from the image conversion unit 42 and displays the overhead view image on the display device in the HMIs 13. In addition, the HMI control unit 40 receives information about the coordinate (targetx, targety) of the target parking position 30 and the angle targetyaw of the longitudinal direction 32 from the matching unit 47 and displays the target parking frame, which indicates a parking space when the vehicle is to be parked at the target parking position 30, in the overhead view image in a superimposing manner.

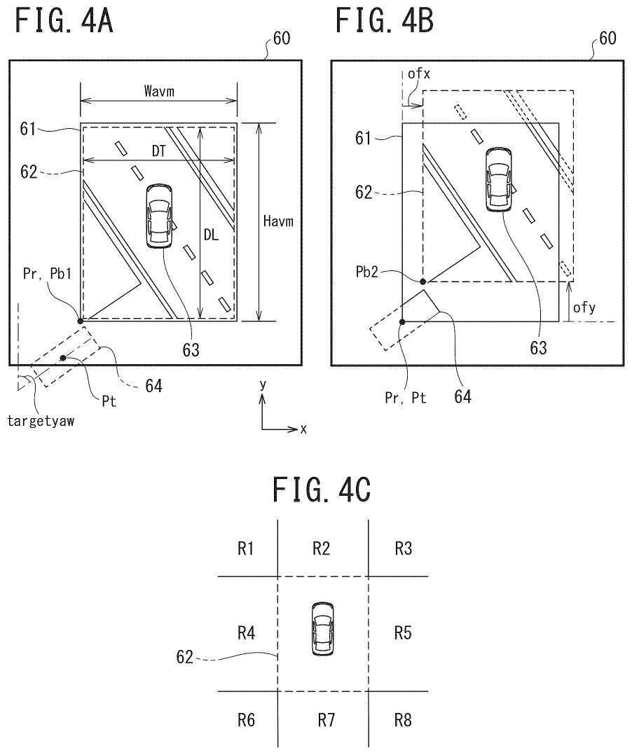

FIG. 4A is a schematic diagram of an example of a display region in which an overhead view image is displayed on the display device in the HMIs 13. A reference numeral 60 denotes a display screen of the display device in the HMIs 13. An overhead view image 62 is displayed in a predetermined display region 61 on the display screen 60. Although in the following description, for the purpose of convenience, a case where a reference point Pr at the lower left corner of the display region 61 is assumed to be a coordinate origin (0, 0) and the rightward direction and the upward direction are assumed to be a positive direction of an x-axis and a positive direction of a y-axis, respectively, is described as an example, a setting of the coordinate system is not limited to the example and may be appropriately changed.

The display region 61 is an area that is set in advance in the display screen 60. The numbers of pixels in the x-axis direction and y-axis direction of the display region 61 are Wavm and Havm, respectively. For example, the numbers of pixels in the x-axis direction and y-axis direction of the display region 61 may be set equal to the numbers of pixels in the x-axis direction and y-axis direction of the overhead view image 62, which is output from the image conversion unit 42 to the HMI control unit 40, respectively. Although in FIG. 4A, the overhead view image 62 is drawn slightly smaller than the display region 61 to facilitate viewing of a boundary of the overhead view image 62, the overhead view image 62 may be displayed to the full extent of the display region 61 (that is, the numbers of pixels in the x-axis direction and y-axis direction of the overhead view image 62 displayed in the display region 61 may be set to Wavm and Havm, respectively).

The overhead view image 62 is an image in which an icon 63 representing the own vehicle 1 is superimposed at the center of the overhead view image representing an area of longitudinal direction length DL and vehicle width direction length DT with the current position of the own vehicle 1 as the center. The longitudinal direction length DL and the vehicle width direction length DT are appropriately set in such a way that the passenger can grasp a sense of distance from a ground object (a road mark, such as a white line, or a road boundary, such as a road shoulder) in the surroundings of the own vehicle 1 that is captured in the overhead view image 62.

In the following description, as a display position at which the overhead view image 62 is displayed in the display region 61, a position at which the lower left corner of the overhead view image 62 is displayed (in the example in FIG. 4A, a position Pb1) is specified.

The HMI control unit 40 calculates a position at which a target parking frame 64 is displayed in the overhead view image 62 in a superimposing manner. Specifically, the HMI control unit 40 calculates a target parking position Pt in a coordinate system on the display screen 60, based on the coordinate (targetx, targety) of the target parking position 30 received from the matching unit 47 and a scale at which the overhead view image 62 is displayed on the display screen 60. In addition, the HMI control unit 40 sets a display position and a direction of the target parking frame 64 in the coordinate system on the display screen 60, based on the angle targetyaw received from the matching unit 47 and the target parking position Pt. For example, the HMI control unit 40 sets the target parking position Pt to a center position of the target parking frame 64 and sets a direction indicated by the angle targetyaw to the longitudinal direction of the target parking frame 64.

Size (longitudinal direction length and lateral direction length) of the target parking frame 64 to be displayed on the display screen 60 may be set according to, for example, the scale of the overhead view image 62 and size of the own vehicle 1. For example, the size of the target parking frame 64 may be set substantially equal to size of an occupation area of the own vehicle 1 in the overhead view image 62. In addition, the size of the target parking frame 64 may be set slightly larger than the occupation area of the own vehicle 1 by setting a margin or may be set slightly smaller than the occupation area of the own vehicle 1. In addition, a size of the target parking frame 64 when the overhead view image 62 is displayed to the full extent of the display region 61 (that is, when the overhead view image 62 with the numbers of pixels in the x-axis direction and the y-axis direction equal to Wavm and Havm, respectively is displayed) may be set in advance as an initial value.

When the parking assistance control is started while the own vehicle 1 is located apart from the target parking position 30, the display position of the target parking frame 64 is sometimes set to the outside of the area of the overhead view image 62, as illustrated in FIG. 4A. In this case, a relative position of the target parking frame 64 with respect to the icon 63 representing the own vehicle 1 cannot be correctly grasped.

Therefore, in a case where when the overhead view image 62 is displayed at the first display position Pb1 on the display screen 60, a predetermined area or more in the target parking frame 64 can be displayed within the display region 61, the HMI control unit 40 displays the overhead view image 62 at the first display position Pb1 on the display screen 60. For example, when the display position at which the overhead view image 62 is to be displayed is set to the first display position Pb1, the HMI control unit 40 determines whether or not a predetermined area or more in the target parking frame 64 can be displayed within the display region 61. In the example in FIG. 4A, the HMI control unit 40 determines whether or not a predetermined area or more in the target parking frame 64 can be displayed within the display region 61 when the overhead view image 62 is displayed to the full extent of the display region 61 (that is, when the overhead view image 62 with the numbers of pixels in the x-axis direction and the y-axis direction equal to Wavm and Havm, respectively is displayed and the first display position Pb1 of the overhead view image 62 is set to the reference point Pr at the lower left corner of the display region 61). In the following description, a predetermined area in the target parking frame 64 is sometimes referred to as “required display area”.

In contrast, in a case where when the overhead view image 62 is displayed at the first display position Pb1 on the display screen 60, a predetermined area or more in the target parking frame 64 cannot be displayed within the display region 61, the HMI control unit 40 displays the overhead view image 62 at a second display position Pb2 on the display screen 60, the second display position Pb2 being different from the first display position Pb1, as illustrated in FIG. 4B. Because of this configuration, the HMI control unit 40 enables a required display area or more in the target parking frame 64 to be displayed within the display region 61. In this case, the HMI control unit 40 may cut off, for example, a portion of the overhead view image 62 that is excluded to the outside of the display region 61 due to the change in the display position and a portion of the target parking frame 64 that is not displayed in the display region 61, and display the rests of the overhead view image 62 and the target parking frame 64 in the display region 61.

The HMI control unit 40 calculates an offset direction (movement direction) and an offset amount (movement amount) of the display position of the overhead view image 62 with respect to the reference position (that is, the first display position Pb1) in such a way that a required display area or more in the target parking frame 64 can be displayed within the display region 61, and calculates the second display position Pb2 by offsetting the first display position Pb1 in the offset direction by the offset amount. FIG. 4C is now referred to. The offset direction of the display position of the overhead view image 62 is determined by the position of the target parking position Pt when the overhead view image 62 is displayed to the full extent of the display region 61. A region R1 is a region in which an x-coordinate is less than 0 and a y-coordinate is greater than Havm, a region R2 is a region in which the x-coordinate is 0 or more and Wavm or less and the y-coordinate is greater than Havm, and a region R3 is a region in which the x-coordinate and the y-coordinate are greater than Wavm and Havm, respectively. A region R4 is a region in which the x-coordinate is less than 0 and the y-coordinate is 0 or more and Havm or less, and a region R5 is a region in which the x-coordinate is greater than Wavm and the y-coordinate is 0 or more and Havm or less. A region R6 is a region in which the x-coordinate and the y-coordinate are less than 0, a region R7 is a region in which the x-coordinate is 0 or more and Wavm or less and the y-coordinate is less than 0, and a region R8 is a region in which the x-coordinate is greater than Wavm and the y-coordinate is less than 0.

For example, when the target parking position Pt is located in the region R1, the offset direction of the display position of the overhead view image 62 may be set to a right-downward direction (the x-coordinate is increased and the y-coordinate is decreased), when the target parking position Pt is located in the region R2, the offset direction of the display position of the overhead view image 62 may be set to the downward direction (without changing the x-coordinate, the y-coordinate is decreased), and when the target parking position Pt is located in the region R3, the offset direction of the display position of the overhead view image 62 may be set to a left-downward direction (the x-coordinate and the y-coordinate are decreased). When the target parking position Pt is located in the region R4, the offset direction of the display position of the overhead view image 62 may be set to the rightward direction (without changing the y-coordinate, the x-coordinate is increased), and when the target parking position Pt is located in the region R5, the offset direction of the display position of the overhead view image 62 may be set to the leftward direction (without changing the y-coordinate, the x-coordinate is decreased). When the target parking position Pt is located in the region R6, the offset direction of the display position of the overhead view image 62 may be set to a right-upward direction (the x-coordinate and the y-coordinate are increased), when the target parking position Pt is located in the region R7, the offset direction of the display position of the overhead view image 62 may be set to the upward direction (without changing the x-coordinate, the y-coordinate is increased), and when the target parking position Pt is located in the region R8, the offset direction of the display position of the overhead view image 62 may be set to a left-upward direction (the x-coordinate is decreased and the y-coordinate is increased).

For example, FIG. 4B illustrates an example of a case where the offset direction and offset amount of the display position of the overhead view image 62 are set in such a manner that, as the required display area in the target parking frame 64, an area larger than or equal to a region including the center of the target parking frame 64 (for example, the target parking position Pt) can be displayed within the display region 61. In the example, based on coordinates (−Px, −Py) of the target parking position Pt when the overhead view image 62 is displayed to the full extent of the display region 61 in FIG. 4A, an x-direction offset amount ofx is set to Px and a y-direction offset amount ofy is set to Py.

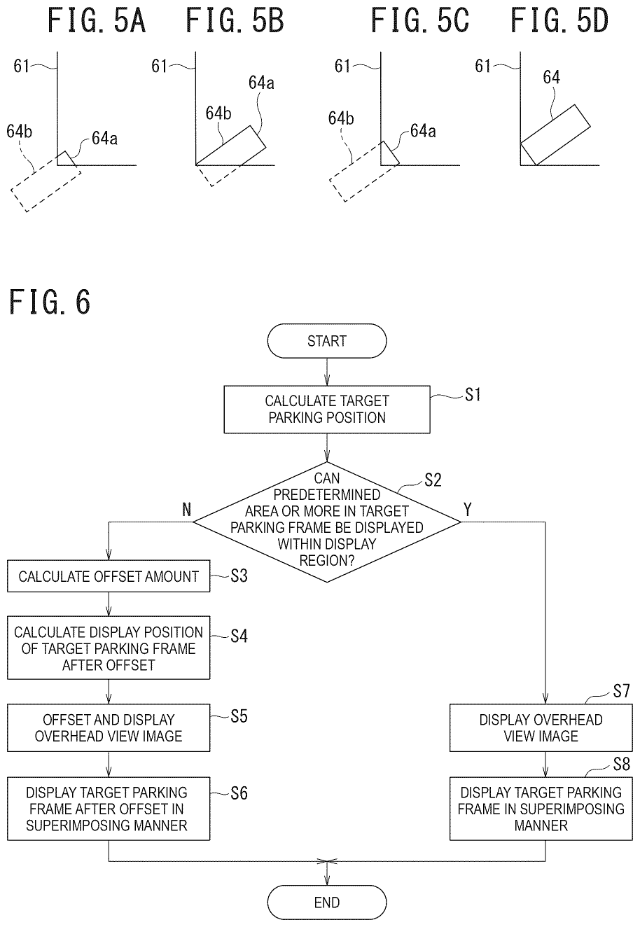

The required display area in the target parking frame 64 is not limited to the above-described example and may be appropriately set in such a way that the target parking frame 64 displayed on the display screen 60 becomes easier to understand for the passenger. For example, the required display area may be an area that includes a portion of each of at least two sides 64a and 64b of the rectangular target parking frame 64 (FIG. 5A), may be an area that includes an entire length of each of the at least two sides 64a and 64b of the rectangular target parking frame 64 (FIG. 5B), may be an area that includes an entire length of at least one short side 64a of the rectangular target parking frame 64 (FIG. 5C), or may be an area that includes all four sides of the rectangular shape (FIG. 5D).

For example, the HMI control unit 40 may calculate coordinates of each of four corners of the rectangular target parking frame 64, based on the target parking position Pt and the angle targetyaw and determine the offset direction and offset amount of the display position of the overhead view image 62 in such a way that the above-described required display area or more can be displayed within the display region 61.

### Operation

FIG. 6 is a flowchart of an example of a parking assistance method of the first embodiment. In step S1, the HMI control unit 40 calculates a target parking position Pt in the coordinate system on the display screen 60. In addition, the HMI control unit 40 calculates a display position and a direction of the target parking frame 64. In step S2, the HMI control unit 40 determines whether or not a predetermined area or more in the target parking frame 64 can be displayed within the display region 61 when the overhead view image 62 is displayed at the first display position Pb1. When the predetermined area or more in the target parking frame 64 cannot be displayed within the display region 61 (step S2: N), the process proceeds to step S3. When the predetermined area or more in the target parking frame 64 can be displayed within the display region 61 (step S2: Y), the process proceeds to step S7.

In step S3, the HMI control unit 40 calculates offset amounts (ofx, ofy) of the display position of the overhead view image 62. In step S4, the HMI control unit 40 calculates a display position of the target parking frame 64 after offset by the offset amounts (ofx, ofy) is performed.

In step S5, the HMI control unit 40 displays the overhead view image 62 at the second display position Pb2 that is a display position offset by the offset amounts (ofx, ofy). In step S6, the HMI control unit 40 displays the target parking frame 64 in a superimposing manner at a display position that is offset-moved (moved) by the offset amounts (ofx, ofy). Subsequently, the process terminates.

In step S7, the HMI control unit 40 displays the overhead view image 62 at the first display position Pb1. In step S8, the HMI control unit 40 displays the target parking frame 64 in a superimposing manner at a position calculated in step S1. Subsequently, the process terminates.

### Second Embodiment

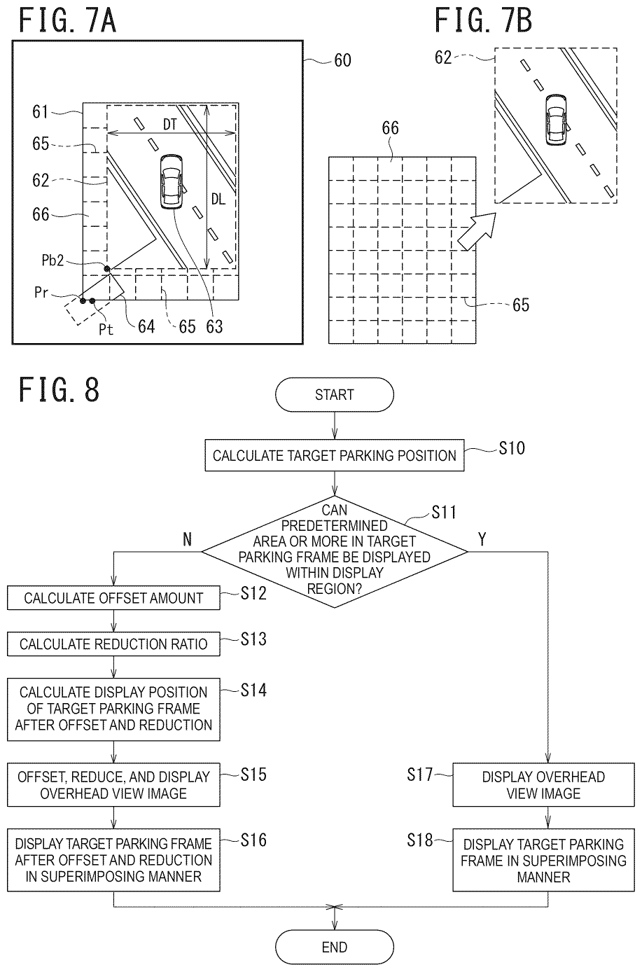

There are some cases where when the display position of the overhead view image 62 is offset while the size of the overhead view image 62 (that is, the scale of the overhead view image 62) is maintained, a portion of the overhead view image 62 is excluded to the outside of the display region 61 and becomes unable to be displayed on the display screen 60. Therefore, in a second embodiment, an overhead view image 62 to be displayed in a display region 61 is reduced, as illustrated in FIG. 7A.

Because of this configuration, the overhead view image 62 can be displayed at a second display position Pb2 in such a manner that all of an area of the overhead view image 62 that can be displayed in the display region 61 when the overhead view image 62 is displayed at a first display position Pb1 as illustrated in FIG. 4A (that is, an area of longitudinal direction length DL and vehicle width direction length DT with a current position of an own vehicle 1 as the center) is included in the display region 61.

For example, when an x-direction offset amount ofx is smaller than a y-direction offset amount ofy, an HMI control unit 40 calculates a reduction ratio scale by the following equation:

$$scale = ( Havm - ofy ) / Havm .$$

When the x-direction offset amount ofx is larger than the y-direction offset amount ofy, the HMI control unit 40 calculates the reduction ratio scale by the following equation:

$$scale = ( Wavm - ofx ) / Wavm .$$

The HMI control unit 40 sets an affine transformation matrix M_{affine2} that offsets display positions of the overhead view image 62 and a target parking frame 64 by the x-direction offset amount ofx and the y-direction offset amount ofy and that also reduces the overhead view image 62 and the target parking frame 64 with the reduction ratio scale, by the following equation.

$${M}_{affine 2} = [ \begin{matrix}scale & 0 & ofx \\ 0 & scale & ofy \\ 0 & 0 & 1\end{matrix} ] \qquad [ Math 4 ]$$

The HMI control unit 40 converts coordinates of the overhead view image 62 and the target parking frame 64 by the affine transformation matrix M_{affine2}. Specifically, when coordinates of each pixel in the overhead view image 62 and coordinates of each point on a boundary of the target parking frame 64 before conversion are denoted by (Px1, Py1), the HMI control unit 40 calculates coordinates of each pixel in the overhead view image 62 and coordinates of each point on a boundary of the target parking frame 64 after offset and reduction that are denoted by (Px2, Py2), by the following equation.

$$[ \begin{matrix}Px 2 \\ Py 2 \\ 1\end{matrix} ] = [ \begin{matrix}scale & 0 & ofx \\ 0 & scale & ofy \\ & & 1\end{matrix} ] [ \begin{matrix}Px 1 \\ Py 1 \\ 1\end{matrix} ] \qquad [ Math 5 ]$$

Note that the HMI control unit 40 may draw grid lines 65 in a background portion (a region in which the overhead view image 62 is not displayed) in the display region 61, as illustrated in FIG. 7A. For example, the HMI control unit 40 may display an image obtained by adding a background image 66 in which a grid is drawn to the overhead view image 62 as illustrated in FIG. 7B, in the display region 61.

FIG. 8 is a flowchart of an example of a parking assistance method of the second embodiment. Processing in steps S10 and S11 is the same as the processing in steps S1 and S2 in FIG. 6. When a predetermined area or more in the target parking frame 64 cannot be displayed within the display region 61 (step S11: N), the process proceeds to step S12. When the predetermined area or more in the target parking frame 64 can be displayed within the display region 61 (step S11: Y), the process proceeds to step S17.

Processing in step S12 is the same as the processing in step S3 in FIG. 6. In step S13, the HMI control unit 40 calculates a reduction ration scale. In step S14, the HMI control unit 40 calculates a display position of the target parking frame 64 when the overhead view image 62 is offset by the offset amounts (ofx, ofy) and is also reduced with the reduction ratio scale.

In step S15, the HMI control unit 40 displays the overhead view image 62 that is offset by the offset amounts (ofx, ofy) and that is also reduced with the reduction ratio scale. In step S16, the HMI control unit 40 displays the target parking frame 64 that is offset by the offset amounts (ofx, ofy) and that is also reduced with the reduction ratio scale, in a superimposing manner. Subsequently, the process terminates.

Processing in steps S17 and S18 is the same as the processing in steps S7 and S8 in FIG. 6.

### Variation

Although in the first and second embodiments, an example in which a relative position of the target parking position 30 with respect to the current position of the own vehicle 1 is detected by matching a target object in the surroundings of the target parking position 30 that is stored in advance with a target object that is detected in the surroundings of the own vehicle 1 when the parking assistance control is performed was described, the parking assistance method of the present invention is not limited to such a determination method of a target parking position. For example, a relative position of the target parking position 30 with respect to the current position of the own vehicle 1 may be detected by detecting a target object indicating that a space is a parking section (for example, a pavement marking, such as a parking slot line, or a three-dimensional object, such as a wheel stopper) at the time of performing the parking assistance control.

### Advantageous Effects of Embodiment

(1) In a parking assistance method including: setting a target parking position at which an own vehicle 1 is to be parked; generating an overhead view image of surroundings of the own vehicle 1 from a captured image obtained by capturing surroundings of the own vehicle 1; and displaying the overhead view image and a guide figure representing an area of a predetermined size surrounding the target parking position in a predetermined display region on a display screen visually recognizable by a passenger of the own vehicle 1, in a case where when an overhead view image is displayed at a first display position on the display screen, a predetermined area or more in the guide figure can be displayed within the display region, an overhead view image is displayed at the first display position in the display screen, and in a case where when an overhead view image is displayed at the first display position on the display screen, the predetermined area or more in the guide figure cannot be displayed within the display region, an overhead view image is displayed at a second display position on the display screen, the second display position being different from the first display position.

Since because of this configuration, the overhead view image of surroundings of the own vehicle 1 and a predetermined area or more in the guide figure can be displayed at the same time even when the own vehicle is located apart from the target parking position, an image that facilitates grasping of a relative position of a target parking frame with respect to the own vehicle can be provided.

(2) When an overhead view image is displayed at the second display position, the overhead view image to be displayed in the display region may be reduced. Because of this configuration, reduction in a display area of the overhead view image after the display position of the overhead view image is changed can be suppressed.

(3) By reducing the overhead view image to be displayed in the display region, the overhead view image including all of an area displayable in the display region when a display position of the overhead view image is set to the first display position may be displayed at the second display position. Because of this configuration, even when the display position of the overhead view image is changed, all of an area of the overhead view image that was displayable before the change can be displayed.

(4) A background image in which a grid is drawn may be added to the overhead view image, and the overhead view image may be displayed in the display region. Because of this configuration, it becomes easier to grasp a sense of distance to a guide figure displayed outside the overhead view image.

(5) The predetermined area in the guide figure may be an area including a portion of each of at least two sides of the guide figure, the guide figure being a rectangular shape. In addition, the predetermined area in the guide figure may be an area including an entire length of each of at least two sides of the guide figure, the guide figure being a rectangular shape. In addition, the predetermined area in the guide figure may be an area including an entire length of at least one short side of the guide figure, the guide figure being a rectangular shape. In addition, the predetermined area in the guide figure may be an area including all of four sides of the guide figure, the guide figure being a rectangular shape. In addition, the predetermined area in the guide figure may be an area including a center point of the guide figure. Because of this configuration, a guide figure can be displayed in such a way as to become easier to understand for a passenger.

(6) The target parking position may be detected based on a captured image obtained by capturing surroundings of the own vehicle 1, a target travel trajectory starting from a current position of the own vehicle 1 and reaching the target parking position may be calculated, and the own vehicle 1 may be controlled in such a way that the own vehicle 1 travels along the target travel trajectory. Because of this configuration, it is possible to assist parking of the own vehicle 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

1 Own vehicle
10 Parking assistance device
11 Positioning device
13 Human-machine interface (HMI)
14 Shift switch (shift SW)
15 External sensor
16 Vehicle sensor
17 Controller
18 Parking brake
19a Steering actuator
19b Accelerator actuator
19c Brake actuator
20 Processor
21 Storage device
40 HMI control unit
41 Parking assistance control unit
42 Image conversion unit
43 Self-position calculation unit
44 Target object detection unit
45 Map generation unit
46 Map data
47 Matching unit
48 Target trajectory generation unit
49 Steering control unit
50 Vehicle speed control unit

1. (canceled)

2. A parking assistance method comprising:
setting a target parking position at which an own vehicle is to be parked;
generating an overhead view image of surroundings of the own vehicle from a captured image obtained by capturing surroundings of the own vehicle; and
displaying the overhead view image and a guide figure representing an area of a predetermined size surrounding the target parking position in a display region on a display screen visually recognizable by a passenger of the own vehicle,
wherein in a case where when an overhead view image is displayed at a first display position on the display screen, a predetermined area or more in the guide figure can be displayed within the display region, the parking assistance method displays an overhead view image at the first display position on the display screen, and
in a case where when an overhead view image is displayed at the first display position on the display screen, the predetermined area or more in the guide figure cannot be displayed within the display region, the parking assistance method displays an overhead view image at a second display position on the display screen, the second display position being different from the first display position,
wherein when an overhead view image is displayed at the second display position, the parking assistance method reduces the overhead view image to be displayed in the display region.

3. The parking assistance method according to claim 2, wherein by reducing the overhead view image to be displayed in the display region, the parking assistance method displays the overhead view image including all of an area displayable in the display region when a display position of the overhead view image is set to the first display position, at the second display position.

4. A parking assistance method comprising:
setting a target parking position at which an own vehicle is to be parked;
generating an overhead view image of surroundings of the own vehicle from a captured image obtained by capturing surroundings of the own vehicle; and
displaying the overhead view image and a guide figure representing an area of a predetermined size surrounding the target parking position in a display region on a display screen visually recognizable by a passenger of the own vehicle,
wherein in a case where when an overhead view image is displayed at a first display position on the display screen, a predetermined area or more in the guide figure can be displayed within the display region, the parking assistance method displays an overhead view image at the first display position on the display screen, and
in a case where when an overhead view image is displayed at the first display position on the display screen, the predetermined area or more in the guide figure cannot be displayed within the display region, the parking assistance method displays an overhead view image at a second display position on the display screen, the second display position being different from the first display position,
wherein the parking assistance method adds a background image in which a grid is drawn to the overhead view image and displays the overhead view image in the display region.

5. The parking assistance method according to claim 2, wherein the predetermined area in the guide figure is an area including a portion of each of at least two sides of the guide figure, the guide figure being a rectangular shape.

6. The parking assistance method according to claim 2, wherein the predetermined area in the guide figure is an area including an entire length of each of at least two sides of the guide figure, the guide figure being a rectangular shape.

7. The parking assistance method according to claim 2, wherein the predetermined area in the guide figure is an area including an entire length of at least one short side of the guide figure, the guide figure being a rectangular shape.

8. The parking assistance method according to claim 2, wherein the predetermined area in the guide figure is an area including all of four sides of the guide figure, the guide figure being a rectangular shape.

9. The parking assistance method according to claim 2, wherein the predetermined area in the guide figure is an area including a center point of the guide figure.

10. The parking assistance method according to claim 2 comprising:
detecting the target parking position, based on a captured image obtained by capturing surroundings of the own vehicle;
calculating a target travel trajectory starting from a current position of the own vehicle and reaching the target parking position; and
controlling the own vehicle in such a way that the own vehicle travels along the target travel trajectory.

11. A parking assistance device including:
a camera configured to capture surroundings of an own vehicle;
a display device including a display screen visually recognizable by a passenger of the own vehicle, setting a target parking position at which the own vehicle is to be parked, generating an overhead view image of surroundings of the own vehicle from a captured image generated by the camera, and displaying the overhead view image and a guide figure representing an area of a predetermined size surrounding the target parking position in a display region on the display screen; and
a controller configured to:
display, in a case where when an overhead view image is displayed at a first display position on the display screen, a predetermined area or more in the guide figure can be displayed within the display region, an overhead view image at the first display position on the display screen;
display, in a case where when an overhead view image is displayed at the first display position on the display screen, the predetermined area or more in the guide figure cannot be displayed within the display region, an overhead view image at a second display position on the display screen, the second display position being different from the first display position, and
reduce the overhead view image to be displayed in the display region when an overhead view image is displayed at the second display position.

12. A parking assistance device including:
a camera configured to capture surroundings of an own vehicle;
a display device including a display screen visually recognizable by a passenger of the own vehicle, setting a target parking position at which the own vehicle is to be parked, generating an overhead view image of surroundings of the own vehicle from a captured image generated by the camera, and displaying the overhead view image and a guide figure representing an area of a predetermined size surrounding the target parking position in a display region on the display screen; and
a controller configured to:
display, in a case where when an overhead view image is displayed at a first display position on the display screen, a predetermined area or more in the guide figure can be displayed within the display region, an overhead view image at the first display position on the display screen;
display, in a case where when an overhead view image is displayed at the first display position on the display screen, the predetermined area or more in the guide figure cannot be displayed within the display region, an overhead view image at a second display position on the display screen, the second display position being different from the first display position, and
add a background image in which a grid is drawn to the overhead view image and displays the overhead view image in the display region.
